(19) United States
(12) Patent Application Publication
(10) Pub. No.: US 2011/0082276 A1
(43) Pub. Date: Apr. 7, 2011

(54) TRANSPARENT POLYIMIDE FILM HAVING IMPROVED SOLVENT RESISTANCE

(75) Inventors: Hyo Jun PARK, Yongin-si (KR); Tae Hwan AHN, Seoul (KR); Hak Gee JUNG, Yongin-si (KR)

(73) Assignee: KOLON INDUSTRIES, INC., Gwacheon-si (KR)

(21) Appl. No.: 12/892,656

(22) Filed: Sep. 28, 2010

(30) Foreign Application Priority Data
Sep. 29, 2009 (KR) 10-2009-0092608

(51) Int. Cl. C08G 69/26

(52) U.S. Cl. 528/335

(57) ABSTRACT

Disclosed herein is a transparent polyimide film having improved solvent resistance, the outer form of which is not changed by swelling or dissolving even when it is immersed in a polar solvent.

### BACKGROUND OF THE INVENTION

1. Technical Field

The present invention relates to a transparent polyimide film having improved solvent resistance.

2. Description of the Related Art

Generally, a polyimide (PI) resin, which is a heat-resistant resin, is prepared by solution-polymerizing an aromatic dianhydride with an aromatic amine or an aromatic diisocyantate to prepare a polyamic acid derivative and then ring-closing and dehydrating the polyamic acid derivative at high temperature to imidize it. In the preparation of a polyimide resin, pyromellitic dianhyride (PMDA), biphenyltetracarboxylic dianhydride (BPDA) or the like is used as the aromatic dianhydride, and oxydianiline (ODA), p-phenylenediamine (p-PDA), m-phenylenediamine (m-PDA), methylenedianiline (MDA), bisaminophenylfluoropropane (HFDA) or the like is used as the aromatic amine.

Such a polyamide resin, which is an insoluble and nonmeltable resin having ultrahigh heat resistance, is widely used in heat-resistant materials for automobiles, aircrafts, spacecrafts and the like, and electronic materials, such as insulating coating agents, insulating films, semiconductors, electrode protection films of TFT-LCD and the like because it has excellent oxidation resistance, heat resistance, radiation resistance, low-temperature characteristics, solvent resistance and the like.

However, polyimide resin is colored brown or yellow because of its high aromatic ring density, so that it has low transmittance in the visible light range, with the result that it is difficult to use it in applications requiring transparency.

Recently, transparent polyimide films have been developed, but their solvent resistances become poorer compared to conventional polyimide films.

In particular, when a polyimide film is used as a film for a substrate or optical coating, if it is exposed to a polar solvent, such as a developer like an acid or a base, and other coating agents, its surface is melted or its form is changed by a swelling effect, so that it is difficult to independently use it without a protective layer.

### SUMMARY OF THE INVENTION

Accordingly, the present invention has been devised to solve the above-mentioned problems, and the present invention intends to provide a transparent polyimide film having improved solvent resistance.

Further, the present invention intends to provide a substrate for displays, which has improved solvent resistance.

A first aspect of the present invention provides a polyimide film having a yellowness of 10 or less, and having a solvent resistance index of 2% or less, wherein the solvent resistance index is represented by Formula 1 below and is defined as a percentage of a difference in thickness between a film which has been immersed in a polar solvent for 10 minutes and a film which was not immersed in the solvent to the thickness of the film which was not immersed in the solvent:

$$( \frac{{t}_{0} - {t}_{1}}{{t}_{0}} ) \times 100 \qquad < Formula 1 >$$

wherein t₀ is the thickness of the film before immersing the film in the solvent, and t₁ is the thickness of the film after immersing the film in the solvent for 10 minutes.

Here, the polar solvent may be selected from dimethylformamide (DMF), dimethylacetamide (DMAc) and N-methyl-2-pyrrolidone (NMP).

Further, the polyimide film may be made of a polyamic acid obtained by polymerizing a dianhydride and an anhydride with a diamine. In this case, the polyimide film may include the anhydride in an amount of 10 mol % or less based on a total amount of the anhydride and dianhydride.

Further, the polyimide film may be obtained by the processes of: polymerizing a dianhydride and an anhydride with a diamine to prepare a polyamic acid solution; forming the polyamic acid solution into a polyimide film by a film forming process; and heat-treating the polyamide film at 310˜500° C. for 1 minute˜3 hours.

Further, the polyimide film may have a transmittance of 85% or more at a thickness of 550 nm.

Further, the polyimide film may have a thermal expansion coefficient (CTE) of 55 ppm/° C. or less at 50˜250° C.

A second aspect of the present invention provides a substrate for displays, comprising the polyimide film of the first aspect of the present invention.

### DESCRIPTION OF THE PREFERRED EMBODIMENTS

Hereinafter, the present invention will be described in detail.

The present invention provides a polyimide film having a yellowness of 10 or less, and having a solvent resistance index of 2% or less, wherein the solvent resistance index is represented by Formula 1 below and is defined as a percentage of a difference in thickness between a film which has been immersed in a polar solvent for 10 minutes and a film which was not immersed in the solvent to the thickness of the film which was not immersed in the solvent:

$$( \frac{{t}_{0} - {t}_{1}}{{t}_{0}} ) \times 100 \qquad < Formula 1 >$$

wherein t₀ is the thickness of the film before immersing the film in the solvent, and t₁ is the thickness of the film after immersing the film in the solvent for 10 minutes.

Here, the polar solvent may be selected from dimethylformamide (DMF), dimethylacetamide (DMAc) and N-methyl-2-pyrrolidone (NMP).

When the solvent resistance of the film is more than 2%, the surface of the film is melted by a solvent or swells even when the thickness deviation of a measuring instrument is taken into account. Therefore, when the film is exposed to a solvent such as a developer during a display device manufacturing process, error patterns occur because the surface thereof changes. Further, even when the surface thereof is coated with a solvent-resistant material, error patterns also occur because the lateral side of the film is also exposed to a solvent. Accordingly, it is difficult to actually use a substrate made of this film in subsequent processes because error patterns occur and dimensions change.

Further, when the solvent resistance thereof is more than 2%, if a solvent drops onto the film, the film is melted by the solvent, and simultaneously the solvent is exposed to the surrounding water, so that the solubility of the film in the solvent is lowered, with the result that the film dissolved in the solvent causes white turbidity.

Therefore, it is preferred that the solvent resistance index of the polyimide film be 2% or less such that the polyimide film is not problematic even when it is exposed to a solvent such as developer.

The polyimide film of the present invention may be formed by cross-linking polyamic acid in order to improve solvent resistance. However, since the polyamic acid must undergo a chemical curing process, a precipitation process and a remelting process in order to form it into a film, if the polyamic acid is previously cross-linked during the above processes, the solubility of the polyamic acid decreases, and thus the polyamic acid can be formed into a film. Therefore, it is required in the above processes that the cross-linking of polyamic acid must not be conducted.

The polyimide film of the present invention is formed by copolymerizing diamine with anhydride and dianhydride and then imidizing the copolymer. In the formation of the polyamide film, in order to improve solvent resistance, the molecular chain of polyimide may be terminally-substituted with anhydride at an equivalent ratio of dianhydride and anhydride:diamine of 1:1.

As such, the polyamide film can be formed by polymerizing a dianhydride and an anhydride with a diamine to prepare a polyamic acid solution, and then imidizing and heat-treating the polyamic acid solution at high temperature.

The dianhydride used in the present invention may include, but is not limited to, one or more selected from 2,2-bis(3,4-dicarboxyphenyl)hexafluoropropane dianhydride (6FDA), 4-(2,5-dioxotetrahydrofuran-3-yl)-1,2,3,4-tetrahydronaphthalene-1,2-dicarboxylic dianhydride (TDA), pyromellitic dianhydride (1,2,4,5-benzenetetracarboxylic dianhydride, PMDA), benzophenone tetracarboxylic dianhydride (BTDA), biphenyl tetracarboxylic dianhydride (BPDA), oxydiphthalic dianhydride (ODPA), biscarboxyphenyl dimethyl silane dianhydride (SiDA), bisdicarboxyphenoxy diphenyl sulfide dianhydride (BDSDA), sulfonyl diphthalic dianhydride (SO₂DPA), cyclobutane tetracarboxylic dianhydride (CBDA), isopropylidenediphenoxy bisphthalic dianhydride (6HBDA).

The diamine used in the present invention may include, but is not limited to, one or more selected from oxydianiline (ODA), p-phenylenediamine (pPDA), m-phenylenediamine (mPDA), p-methylenediamine (pMDA), m-methylenediamine (mMDA), bisaminophenoxy benzene (133APB, 134APB), bisaminophenoxyphenyl hexafluoropropane (4BDAF), bisaminophenyl hexafluoropropane (33-6F, 44-6F), bisaminophenyl sulfone (ODDS, 3DDS), bistrifluoromethyl benzidine (TFDB), cyclohexanediamine (13CHD, 14-CHD), bisaminophenoxyphenyl propane (6HMDA), bisaminohydroxyphenyl hexafluoropropane (DBOH), bisaminophenoxy diphenyl sulfone (DBSDA).

The anhydride used in the present invention may be selected from, but is not limited to, unsaturated compounds such as Nadic anhydride (bicyclo[2.2.1]-5-heptene-2,3-dicarboxylic anhydride), 4-(9-anthracenyl ethynyl)phthalic anhydride, and the like.

The dianhydride, anhydride and diamine are dissolved in a first solvent and react with each other to prepare a polyamic acid solution.

Reaction conditions are not particularly limited, but it is preferred that the reaction temperature be −20˜80° C. and the reaction time be 2˜48 hours. Further, it is preferred that the reaction be conducted under an inert atmosphere of argon, nitrogen or the like.

Meanwhile, the molecular weight of the polyimide is influenced by the amount of anhydride that is added at the time of reaction. In this case, in order not to deteriorate the specific material properties of the polyimide, the anhydride may be added in an amount of 10 mol % or less, preferably, 2 mol % or less, based on the total amount of the anhydride and dianhydride. When the amount of anhydride added is more than 10 mol %, since the molecular weight of the polyimide decreases, yellowness increases, and transmittance decreases, that is, optical characteristics deteriorate. Conversely, since the amount of cross-linking in the polyimide is related to the increase in the amount of the anhydride, it can be expected that thermal properties are improved thereby. However, when polyimide is excessively cross-linked, polymer chains are not regularly arranged, and thus the thermal expansion coefficient (CTE) increases, that is, thermal properties deteriorate.

The first solvent used to solution-polymerize the monomers is not particularly limited as long as it can dissolve polyamic acid. Examples of the first solvent may include one or more commonly-known polar solvents selected from m-cresol, N-methyl-2-pyrrolidone (NMP), dimethylformamide (DMF), dimethylacetamide (DMAc), dimethylsulfoxide (DMSO), acetone, and diethyl acetate. In addition, examples of the first solvent may include low melting point solvents such as tetrahydrofuran (THF) and chloroform, and a low-absorption solvent such as γ-butyrolactone.

The amount of the first solution is not particularly limited. However, in order to obtain a polyamic acid solution having a suitable molecular weight and viscosity, the amount of the first solvent may be 50˜95 wt %, preferably 70˜90 wt %, based on the total amount of a polyamic acid solution.

The polyamic acid solution prepared in this way is imidized to prepare a polyimide resin, and the prepared polyimide resin may have a glass transition temperature of 200˜400° C. in consideration of thermal stability.

Moreover, when a polyimide film is formed using the polyamic acid solution, in order to improve several material properties of the polyimide film, such as slippability, thermal conductivity, electrical conductivity and corona resistance, a filler may be added to the polyamic acid solution. Examples of the filler may include, but are not limited to, silica, titanium oxides, layered silica, carbon nanotubes, alumina, silicon nitride, boron nitride, calcium hydrogen phosphate, calcium phosphate, mica, and the like.

The particle size of the filler may be changed depending on the characteristics of the polyimide film that should be improved and the kind of the filler that is added, and is not particularly limited. Generally, the filler may have an average particle size of 0.001˜50 μm, preferably 0.005˜25 μm, more preferably 0.01˜10 μm. In this case, it is easy to reform the polyimide film, and it is possible to obtain a polyimide film having excellent surface properties, conductivity, and mechanical properties.

Further, the amount of the filler added may also be changed depending on the characteristics of the polyimide film that should be improved or on the particle size of the filler, and is not particularly limited. Generally, in order not to interfere with the bonding structure of a polymer resin and to allow the characteristics of the polymer resin to be improved, the amount of the filler added may be 0.001˜20 parts by weight, preferably 0.01˜10 parts by weight, based on 100 parts by weight of the polyamic acid solution.

Methods of adding the filler are not particularly limited. For example, there may be a method of adding the filler to the polyamic acid solution before or after polymerization, a method of kneading the filler using a 3-roll mill, a method of preparing a dispersion solution containing the filler and then mixing the dispersion solution with the polyamic acid solution, and the like.

The method of forming a polyimide film using the obtained polyamic acid solution can be carried out using conventional commonly-known methods. That is, the polyimide film can be formed by casting the polyamic acid solution on a support and then imidizing the cast polyamic acid solution.

In this case, the polyamic acid solution may be imidized by thermal imidization, chemical imidization or a combination thereof. In the case of chemical imidization, a dehydrating agent represented by an acid anhydride such as acetic acid anhydride and an imidization catalyst represented by tertiary amines such as isoquinoline, β-picoline, pyridine and the like are introduced into the polyamic acid solution. In the case of thermal imidization or a combination of thermal imidization and chemical imidization, the heat conditions of the polyamic acid solution may be changed depending on the kind of the polyamic acid solution and the thickness of the polyimide film formed using the polyamic acid solution.

Concretely, if thermal imidization and chemical imidization are combined, the polyamide film may be obtained by the processes of: introducing a dehydrating agent and an imidization catalyst into a polyamic acid solution to cast the polyamic acid solution on a support; heating the cast polyamic acid solution to a temperature of 80˜200° C., preferably 100˜180° C. to activate the dehydrating agent and the imidization catalyst; partially curing and drying the heated polyamic acid solution to form a gel-state polyamic acid film; separating the gel-state polyamic acid film from the support; and fixing the separated gel-state polyamic acid film on a holder and then heating it to a temperature of 200˜400° C. for 5˜400 seconds. Here, the gel-state polyamic acid film may be fixed on the holder using a pin or a clip. As the support, a glass plate, aluminum foil, stainless belt, stainless drum or the like may be used.

Meanwhile, in the present invention, the polyamide film may also be formed using the obtained polyamic acid solution as follows. That is, the polyamide film may be formed by the processes of: imidizing the polyamic acid solution; introducing the imidized polyamic acid solution into a second solvent; precipitating, filtering and then drying the imidized polyamic acid solution to obtain solids of a polyimide resin; dissolving the solids in a first solvent to prepared a polyimide solution; and forming the polyimide solution into a polyimide film by a film forming process.

As described above, the imidization of the polyamic acid solution may be conducted by thermal imidization, chemical imidization or a combination thereof. Concretely, in the case of combining thermal imidization and chemical imidization, the polyamic acid solution may be imidized by introducing a dehydrating agent and an imidization catalyst thereinto and then heating it to a temperature of 20˜180° C. for 1˜12 hours.

The first solvent may be the same as the one used in the polymerization of the polyamic acid solution. As the second solvent, a solvent having lower polarity than the first solvent may be used. Concretely, the second solvent may be one or more selected from water, alcohols, ethers, and ketones.

In this case, the amount of the second solvent may be, but is not particularly limited to, 5˜20 parts by weight that of the polyamic acid solvent.

The filtered solids of a polyimide resin may be dried at 50˜120° C. for 3˜24 hours depending on the boiling point of the second solvent.

Subsequently, in the film forming process, the polyimide solution in which the solids of a polyimide resin are dissolved is cast on a support, and then slowly heated within a temperature range of 40˜400° C. for 1 minute˜8 hours to obtain the polyimide film.

In the present invention, the obtained polyimide film may be further heat-treated. The heat treatment may be conducted at a temperature of 310˜500° C. for 1 minute˜3 hours.

The reason for this is that when the final heat treatment is conducted at below 310° C., anhydride disposed at the end of polyimide is not cross-linked, and thus specific properties of the polyimide film are not exhibited.

The amount of volatile components remaining in the heat-treated polyimide film may be 5 wt % or less, preferably, 3 wt % or less.

The thickness of the obtained polyimide film may be, but is not particularly limited to, 10˜250 μm, preferably 25˜150 μm.

Hereinafter, the present invention will be described in more detail with reference to the following Examples. However, the scope of the present invention is not limited thereto.

### Example 1

A 1 L reactor provided with a stirrer, a nitrogen injector, a dropping funnel, a temperature controller and a cooler was filled with 330 g of N,N-dimethylacetamide (DMAc) while nitrogen was being passed through it, and then the temperature of the reactor was adjusted to 25° C. Then, 38.42 g (0.12 mol) of TFDB was dissolved in the N,N-dimethylacetamide (DMAc) to form a first solution, and then the temperature of the first solution was adjusted to 25° C. Then, 17.65 g (0.06 mol) of BPDA was added to the first solution, and then stirred for 3 hours to completely dissolve the BPDA in the first solution to form a second solution, and then the temperature of the second solution was adjusted to 25° C. Then, 26.39 g (0.0594 mol) of 6FDA was added to the second solution, and then stirred for 4 hours to form a third solution. Then, 0.0197 g (0.0012 mol) of Nadic Anhydride was added to the third solution to obtain a polyamic acid solution having a solid content of 20 wt %.

The polyamic acid solution was stirred at room temperature for 8 hours. Subsequently, 19.98 g of pyridine, serving as an imidization catalyst, and 24.48 g of acetic anhydride were added to the polyamic acid solution, stirred for 30 minutes, further stirred at 80° C. for 2 hours and then cooled to room temperature to form a fourth solution. Then, the fourth solution was slowly introduced into a vessel filled with 20 L of methanol to precipitate solids. Subsequently, the precipitated solids were filtered, pulverized and then dried in a vacuum at 80° C. for 6 hours to obtain 75 g of solid powder. Subsequently, the obtained solid powder was further dissolved in 300 g of N,N-dimethylacetamide (DMAc) to obtain 15 wt % of a solution having a viscosity of 200 poise.

After the reaction was completed, the obtained solution was applied on a stainless plate, cast to a thickness of 700 μm, and then dried using hot air at 150° C. within 30 minutes to form a film. The film was separated from the stainless plate and then fixed on a frame using a pin.

Subsequently, the frame fixed with the film was put into a hot-air oven, slowly heated from 100° C. to 330° C. for 2 hours, and then slowly cooled to separate the film from the frame to obtain a polyimide film. Finally, the obtained polyimide film was further heat-treated at 330° C. for 30 minutes (thickness: 100 μm).

### Example 2

A 1 L reactor provided with a stirrer, a nitrogen injector, a dropping funnel, a temperature controller and a cooler was filled with 330 g of N,N-dimethylacetamide (DMAc) while nitrogen was being passed through it, and then the temperature of the reactor was adjusted to 25° C. Then, 38.42 g (0.12 mol) of TFDB was dissolved in the N,N-dimethylacetamide (DMAc) to form a first solution, and then the temperature of the first solution was adjusted to 25° C. Then, 17.65 g (0.06 mol) of BPDA was added to the first solution, and then stirred for 3 hours to completely dissolve the BPDA in the first solution to form a second solution, and then the temperature of the second solution was adjusted to 25° C. Then, 25.59 g (0.0576 mol) of 6FDA was added to the second solution, and then stirred for 4 hours to form a third solution. Then, 0.0788 g (0.0048 mol) of Nadic Anhydride was added to the third solution to obtain a polyamic acid solution having a solid content of 20 wt %.

The polyamic acid solution was stirred at room temperature for 8 hours. Subsequently, 19.98 g of pyridine, serving as an imidization catalyst, and 24.48 g of acetic anhydride were added to the polyamic acid solution, stirred for 30 minutes, further stirred at 80° C. for 2 hours and then cooled to room temperature to form a fourth solution. Then, the fourth solution was slowly introduced into a vessel filled with 20 L of methanol to precipitate solids. Subsequently, the precipitated solids were filtered, pulverized and then dried in a vacuum at 80° C. for 6 hours to obtain 75 g of solid powder. Subsequently, the obtained solid powder was further dissolved in 300 g of N,N-dimethylacetamide (DMAc) to obtain 15 wt % of a solution having a viscosity of 52 poise.

Thereafter, a polyimide film was obtained in the same manner as in Example 1.

### Example 3

A 1 L reactor provided with a stirrer, a nitrogen injector, a dropping funnel, a temperature controller and a cooler was filled with 330 g of N,N-dimethylacetamide (DMAc) while nitrogen was being passed through it, and then the temperature of the reactor was adjusted to 25° C. Then, 38.42 g (0.12 mol) of TFDB was dissolved in the N,N-dimethylacetamide (DMAc) to form a first solution, and then the temperature of the first solution was adjusted to 25° C. Then, 17.65 g (0.06 mol) of BPDA was added to the first solution, and then stirred for 3 hours to completely dissolve the BPDA in the first solution to form a second solution, and then the temperature of the second solution was adjusted to 25° C. Then, 23.99 g (0.054 mol) of 6FDA was added to the second solution, and then stirred for 4 hours to form a third solution. Then, 1.97 g (0.012 mol) of Nadic Anhydride was added to the third solution to obtain a polyamic acid solution having a solid content of 20 wt %.

The polyamic acid solution was stirred at room temperature for 8 hours. Subsequently, 19.98 g of pyridine, serving as an imidization catalyst, and 24.48 g of acetic anhydride were added to the polyamic acid solution, stirred for 30 minutes, further stirred at 80° C. for 2 hours and then cooled to room temperature to form a fourth solution. Then, the fourth solution was slowly introduced into a vessel filled with 20 L of methanol to precipitate solids. Subsequently, the precipitated solids were filtered, pulverized and then dried in a vacuum at 80° C. for 6 hours to obtain 75 g of solid powder. Subsequently, the obtained solid powder was further dissolved in 300 g of N,N-dimethylacetamide (DMAc) to obtain 15 wt % of a solution having a viscosity of 23 poise.

Thereafter, a polyimide film was obtained in the same manner as in Example 1.

### Comparative Example 1

A film was formed in the same manner as in Example 1. The film was fixed on a frame, slowly heated to 150˜300° C. for 2 hours and then cooled to separate the film from the frame and obtain a polyimide film. Finally, the obtained polyimide film was further heat-treated at 300° C. for 30 minutes (thickness: 100 μm).

### Comparative Example 2

The reactor was filled with 609.54 g of N,N-dimethylformamide (DMF), and then the temperature of the reactor was adjusted to 25° C. Then, 70.084 g of 4,4′-diaminodiphenyl ether (ODA), which is an amine, was dissolved in the N,N-dimethylformamide (DMF) to form a first solution. Then, 76.34 g of PMDA was added to the first solution, and then stirred at 25° C. for 2 hours to form a second solution.

Subsequently, the reactor was heated to 40° C., and then the second solution was stirred for 1 hour at 40° C. to obtain a polyamic acid solution having a solid content of 18.5 wt % and a viscosity of 2570 poise. In this case, for the introduced monomers, PMDA has a molar ratio of 100%, and ODA also has a molar ration of 100%.

100 g of this polyamic acid solution was mixed with 50 g of catalyst solution including 7.2 g of isoquinoline and 22.4 g of acetic anhydride, uniformly stirred, applied on a stainless plate, cast to a thickness of 100 μm, and then dried using hot air at 150° C. for 5 minutes to form a film. Then, the film was separated from the stainless plate and then fixed on a frame using a pin.

Subsequently, the frame fixed with the film was put into a hot-air oven, slowly heated from 100° C. to 350° C. for 30 minutes, and then slowly cooled to separate the film from the frame to obtain a polyimide film. Finally, the obtained polyimide film was further heat-treated at 350° C. for 30 minutes (thickness: 25 μm).

### Comparative Example 3

The reactor was filled with 611 g of N,N-dimethylacetamide (DMAc), and then the temperature of the reactor was adjusted to 25° C. Then, 64.046 g (0.2 mol) of TFDB was dissolved in the N,N-dimethylacetamide (DMAc) to form a first solution, and then the temperature of the first solution was adjusted to 25° C. Then, 88.85 g (0.2 mol) of 6FDA was added to the first solution to obtain a polyamic acid solution having a solid content of 20 wt %.

The polyamic acid solution was stirred at room temperature for 8 hours. Subsequently, 31.64 g of pyridine, serving as an imidization catalyst, and 40.91 g of acetic anhydride were added to the polyamic acid solution, stirred for 30 minutes, further stirred at 80° C. for 2 hours and then cooled to room temperature to form a second solution. Then, the second solution was slowly introduced into a vessel filled with 20 L of methanol to precipitate solids. Subsequently, the precipitated solids were filtered, pulverized and then dried in a vacuum at 80° C. for 6 hours to obtain 136 g of solid powder. Subsequently, the obtained solid powder was further dissolved in 496 g of N,N-dimethylacetamide (DMAc) to obtain 20 wt % of a solution having a viscosity of 71 poise.

Thereafter, a polyimide film was obtained in the same manner as in Example 1.

(1) Transmittance

The transmittance of each of the polyimide films formed in the Examples at a wavelength of 550 nm was measured using a UV spectrometer (Cary 100, manufactured by Varian Corp.).

(2) Yellowness

The yellowness thereof was measured based on ASTM E313 standards.

(3) Thermal Expansion Coefficient (CTE)

The thermal expansion coefficient (CTE) thereof was measured at 50˜250° C. three times by a first run, second run and third run based on the TMA-Method using a TMA (Diamond TMA, manufactured by Perkin Elmer Corp.). Here, the average thermal expansion coefficient (CTE) thereof was calculated using the values measured in the second run and third run, excluding the first run.

(4) Thickness Measurement and Thickness Deviation

A polyimide film was dried in a vacuum oven at 80° C. for 1 hour, and then the thicknesses of the dried polyimide film was measured at five points thereof. Further, samples (2 cm×2 cm) of the polyimide film were immersed in a 100 ml beaker filled with 50 ml of 100% DMAc for 10 minutes, washed with water and then dried in a vacuum oven at 80° C. for 1 hour, and then the thicknesses of the dried samples were measured at five points thereof. The solvent resistance index was calculated with Formula 1 below.

The thickness of the polyimide film was measured by an anritsu electronic micrometer, and the deviation of the anritsu electronic micrometer is ±0.5% or less.

$$( \frac{{t}_{0} - {t}_{1}}{{t}_{0}} ) \times 100 \qquad < Formula 1 >$$

wherein, t₀ is the thickness of the polyimide film before immersing it in the solvent, and t₁ is the thickness of the polyimide film after immersing it in the solvent for 10 minutes.

(5) White Turbidity

The white turbidity thereof was observed with the naked eye after applying a drop of 100% DMAc onto the sample (2 cm×2 cm) of each of the polyimide films prepared in Examples and Comparative Examples.

◯: White turbidity occurs

X: White turbidty does not occur

TABLE 1

| | | Equivalent ratio | | | |
|---|---|---|---|---|---|
| | Components | (amine:anhydride) | Thickness | Yellowness | Transmittance |
| Exp. 1 | 6FDA/BPDA/TFDB/ND | 1:1 | 100 | 3.5 | 89.1 |
| Exp. 2 | 6FDA/BPDA/TFDB/ND | 1:1 | 100 | 6.4 | 88.1 |
| Exp. 3 | 6FDA/BPDA/TFDB/ND | 1:1 | 100 | 9.2 | 86.3 |
| Co. Exp. 1 | 6FDA/BPDA/TFDB/ND | 1:1 | 100 | 3.4 | 89.4 |
| Co. Exp. 2 | PMDA/ODA | 1:1 | 25 | 91.7 | 73.7 |
| Co. Exp. 3 | 6FDA/BPDA/TFDB | 1:1 | 100 | 3.37 | 89.5 |

TABLE 2

| | | | Thickness | | | |
|---|---|---|---|---|---|---|
| | | | after | | | |
| | | | solvent | Thickness | | |
| | | Thickness | treatment | Deviation | CTE | White |
| | Components | (μm) | (μm) | (%) | (50~250° C.) | turbidity |
| Exp. 1 | 6FDA/BPDA/TFDB/ND | 100 | 99.5 | 0.5 | 40.2 | x |
| Exp. 2 | 6FDA/BPDA/TFDB/ND | 100 | 99.7 | 0.3 | 46 | x |
| Exp. 3 | 6FDA/BPDA/TFDB/ND | 100 | 100.4 | 0.4 | 52 | x |
| Co. Exp. 1 | 6FDA/BPDA/TFDB/ND | 100 | 97.8 | 2.2 | 40 | ∘ |
| Co. Exp. 2 | PMDA/ODA | 25 | 24.7 | 0.3 | 26.1 | x |
| Co. Exp. 3 | 6FDA/BPDA/TFDB | 100 | 96.1 | 2.9 | 39.6 | ∘ |

1. A polyimide film having a yellowness of 10 or less, and having a solvent resistance index of 2% or less, wherein the solvent resistance index is represented by Formula 1 below and is defined as a percentage of a difference in thickness between a film which has been immersed in a polar solvent for 10 minutes and a film which was not immersed in the solvent to the thickness of the film which was not immersed in the solvent:
$$( \frac{{t}_{0} - {t}_{1}}{{t}_{0}} ) \times 100 \qquad < Formula 1 >$$
wherein t₀ is a thickness of the film before immersing the film in the solvent, and t₁ is a thickness of the film after immersing the film in the solvent for 10 minutes.

2. The polyimide film according to claim 1, wherein the polar solvent is selected from dimethylformamide (DMF), dimethylacetamide (DMAc) and N-methyl-2-pyrrolidone (NMP).

3. The polyimide film according to claim 1, wherein the polyimide film is made of a polyamic acid obtained by polymerizing a dianhydride and an anhydride with a diamine.

4. The polyimide film according to claim 3, wherein the polyimide film includes the anhydride in an amount of 10 mol % or less based on a total moles of the anhydride and the dianhydride.

5. The polyimide film according to claim 1, wherein the polyimide film is obtained by processes of: polymerizing a dianhydride and an anhydride with a diamine to prepare a polyamic acid solution; forming the polyamic acid solution into a polyimide film by a film forming process; and heat-treating the polyimide film at 310˜500° C. for 1 minute˜3 hours.

6. The polyimide film according to claim 1, wherein the polyimide film has a transmittance of 85% or more at a thickness of 550 nm.

7. The polyimide film according to claim 1, wherein the polyimide film has a thermal expansion coefficient (CTE) of 55 ppm/° C. or less at 50˜250° C.

8. A substrate for displays, comprising the polyimide film of claim 1.
